(19) United States
(12) Patent Application Publication
(10) Pub. No.: US 2007/0048467 A1
(43) Pub. Date: Mar. 1, 2007

(54) Information recording medium

(75) Inventors: Kimihiko Kaneno, Osaka (JP); Yasuaki Okumura, Osaka (JP); Ryuta Homma, Osaka (JP); Yota Matsuki, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/508,304

(22) Filed: Aug. 23, 2006

(30) Foreign Application Priority Data
Aug. 24, 2005 (JP) 2005-243302
Aug. 24, 2005 (JP) 2005-243303

(51) Int. Cl. B41M 5/40

(52) U.S. Cl. 428/32.31

(57) ABSTRACT

A first information recording medium according to the present invention includes a substrate and an ink receiving layer disposed on one main face of the substrate. The water contact angle of the surface of the ink receiving layer is at least 85° and at most 110°. The surface of the ink receiving layer is provided with protrusions with a height of at least 4 μm. The number of the protrusions is at least 20 pcs/mm² and at most 100 pcs/mm². Furthermore, in a second information recording medium according to the present invention, the ink receiving layer contains particles with a particle size of at least 20 μm. The particles include particles that are exposed partially on the surface of the ink receiving layer. The number of these particles is at least 75 pcs/mm² and at most 250 pcs/mm².

### BACKGROUND OF THE INVENTION

1. Field of the Invention

The present invention relates to an information recording medium in which an ink receiving layer is provided on one face of a substrate.

2. Description of the Related Art

In recent years, with the widespread availability of personal computers, various types of information recording media used therein also rapidly become widespread. For example, optical information recording media on which information can be written and/or read using a laser beam are widely used as information recording media in the fields of audio software, computer software, game software, electronic publishing, and the like.

Optical information recording media can be divided into two types, i.e., a write-once type in which optical information can be recorded and reproduced, and a rewritable type in which data can be erased after recording. Of these, CD-R5 (write-once type) and CD-RWs (rewritable type) that are optical information recording media of a CD type are widely used. Furthermore, more people have come to use DVD-R5 (write-once type), DVD-RWs (rewritable type), and DVD-RAMs that are optical information recording media of a DVD type.

Furthermore, with the development of image forming apparatuses such as inkjet printers, optical information recording media have been proposed in which an ink receiving layer is provided on a face opposite to a face that is irradiated with a laser beam during recording or reproduction, that is, a so-called label surface (see JP H08-279179A, for example). Users of optical information recording media can print photographs, pictures, or characters on the ink receiving layer using apparatuses such as inkjet printers.

FIG. 3 is a plan view showing one example of a conventional optical information recording medium. In FIG. 3, a conventional optical information recording medium 30 is provided with a label surface 30a having an ink receiving layer 31 that is a print area thereof and a clamp area 32 for fixing the optical information recording medium 30 during, for example, production or use, and a center hole 33 on the center thereof. The ink receiving layer 31 covers from the outer circumference of the label surface 30a to the outer circumference of the clamp area 32.

Moreover, as the demands for optical information recording media having a wider printable area recently increase, optical information recording media have been proposed in which an ink receiving layer further extends to the inner side of a clamp area (see JP 2004-253071A, for example).

FIG. 4 is a plan view of a conventional optical information recording medium described in JP 2004-253071A. In FIG. 4, an optical information recording medium 40 is provided with a label surface 40a having an ink receiving layer 41 that is a print area thereof and a clamp area 42, and a center hole 43 on the center thereof. Furthermore, the ink receiving layer 41 covers from the outer circumference of the label surface 40a over the clamp area 42, and further extends to the inner side of the clamp area 42.

It should be noted that a related technique regarding a material for forming an ink receiving layer is disclosed in, for example, JP 2004-338206A.

An information recording medium may be kept in a recording/reproducing apparatus (drive) also when information is neither recorded nor reproduced. On the other hand, an ink receiving layer generally is designed to absorb water in ink, and thus the ink receiving layer becomes viscous or adhesive because of being melted, for example. The viscosity or adhesion increases especially in a high temperature and high humidity environment. In this case, an information recording medium in which an ink receiving layer is provided up to a clamp area as shown in FIG. 4 has a problem in that the information recording medium adheres to a clamp because the ink receiving layer is viscous. When the information recording medium adheres to a clamp in this manner, there is the possibility that the information recording medium cannot be removed from the drive, and the drive or the information recording medium may be damaged.

### SUMMARY OF THE INVENTION

A first information recording medium according to the present invention is an information recording medium provided with a substrate and an ink receiving layer disposed on one main face of the substrate, in which the water contact angle of a surface of the ink receiving layer is at least 85° and at most 110°, in which the surface of the ink receiving layer is provided with protrusions with a height of at least 4 μm, and in which the number of the protrusions is at least 20 pcs/mm² and at most 100 pcs/mm².

Furthermore, a second information recording medium according to the present invention is an information recording medium provided with a substrate and an ink receiving layer disposed on one main face of the substrate, in which the water contact angle of a surface of the ink receiving layer is at least 85° and at most 110°, in which the ink receiving layer contains particles with a particle size of at least 20 μm, in which the particles include particles that are exposed partially on the surface of the ink receiving layer, and in which the number of the exposed particles is at least 75 pcs/mm² and at most 250 pcs/mm².

According to the present invention, it is possible to provide an information recording medium that does not adhere to a clamp in a high temperature and high humidity environment even when an ink receiving layer is provided up to a clamp area.

### BRIEF DESCRIPTION OF THE DRAWINGS

FIG. 1 is a plan view of an optical information recording medium that is one example of an information recording medium according to the present invention.

FIG. 2 is a cross-sectional view of the main portions of the optical information recording medium in FIG. 1.

FIG. 3 is a plan view showing one example of a conventional optical information recording medium.

FIG. 4 is a plan view showing another example of a conventional optical information recording medium.

### DESCRIPTION OF THE PREFERRED EMBODIMENTS

### Embodiment 1

A first information recording medium according to the present invention is provided with a substrate and an ink receiving layer disposed on one main face of this substrate.

The water contact angle of the surface of the ink receiving layer is 85° or more and 110° or less, and more preferably 85° or more and 105° or less. When the water contact angle is less than 85°, the information recording medium adheres to a clamp (hereinafter, this phenomenon may be simply referred to as “clamp adhesion”) in a high temperature and high humidity environment. When the water contact angle is more than 1100, ink is repelled and thus blurring occurs during printing.

Various methods for measuring the water contact angle have been proposed, but in this specification, measurement is performed with a measuring apparatus as set forth below and measurement conditions as set forth below. As a measuring apparatus, a dynamic contact angle tester “DAT1122mkII” (produced by FIBRO system ab) is used. Measurement conditions are as follows. Measurement is performed in the contact angle measurement mode, and Image Seq. is set to NORMAL mode. Distilled water is used as a measurement solvent. A fluororesin tube with an inner diameter of 0.2 mm is used as a tube from a syringe. In the measurement conditions, the drop amount is 4 μL, the stroke is 8, the mode is 22, the step is 1, the time-out is 1.0 minute, and the drop is 5. A slice of the information recording medium is placed on a sample stage, and the measurement is performed at arbitrary 10 points on the slice. An average value of measurement values between 9 to 11 seconds of the thus obtained data is taken as the water contact angle of the sample.

Furthermore, the surface of the ink receiving layer is provided with protrusions with a height of 4 μm or more and 50 μm or less. When the height of the protrusions is less than 4 μm, clamp adhesion can occur after printing. When the height of the protrusions is more than 50 μm, an erroneous blank can appear in printing. The number of the protrusions is 20 pcs/mm² or more and 100 pcs/mm² or less, and more preferably 20 pcs/mm² or more and 80 pcs/mm² or less. When the number of the protrusions is less than 20 pcs/mm², clamp adhesion can occur after printing. When the number of the protrusions is more than 100 pcs/mm², an erroneous blank can appear in printing.

There is no specific limitation regarding a method for measuring the height and the number of the protrusions, but it is possible to use the following method, for example. First, the surface of the ink receiving layer of the information recording medium is irradiated with light with an incident angle of 75°, and is observed using a metallographic microscope. Accordingly, illuminated dots and shadows are observed on the surface of the ink receiving layer. These shadows are used so that the metallographic microscope is focused on the surface of the ink receiving layer. The illuminated dots represent the tops of the protrusions, and the length of the shadows indicates the height of the protrusions. In this observation, the incident angle of the irradiated light has been set to 75°, and thus a value that is obtained by multiplying a tangent (tan(90-75)⁰) by the length from the illuminated dot to the front end of the shadow is taken as the height of the protrusion. When the height and the number of the protrusions are measured by this method, it is preferable to take a metallographic microscope photograph of the surface of the ink receiving layer, and to measure the height and the number of the protrusions based on the photograph in consideration of the scale factor of the photograph. More specifically, this photograph may be taken as photographs (72.5 mm×95.0 mm, scale factor: ×100) at least at three points.

The protrusions can be formed by letting the ink receiving layer contain particles of a specific particle size and exposing a part of the particles on the surface of the ink receiving layer. The ink receiving layer generally contains particles in order to improve ink absorbency, but in the present invention, the protrusions are formed by exposing particles of a specific particle size on the surface of the ink receiving layer, so that clamp adhesion after printing is prevented.

There is no specific limitation regarding the type of particles forming the protrusions, but examples of the particles include fine particles made of an acrylic resin, a methacrylic resin, polyacrylic acid ester, polymethacrylic acid ester, a styrene resin, polyester, polycarbonate, a modified melamine resin, polyvinyl alcohol, polyacrylamide, polyvinyl pyrrolidone, rubber, and the like; crosslinking fine particles of these resins; and organic particles such as powders of lignin, protein, and cellulose. It is also possible to use inorganic particles of titanium oxide, silica, talc, clay, calcium carbonate, calcium silicate, barium sulphate, mica, diatomaceous earth silica, aluminium hydroxide, alumina, zirconium oxide, and zirconium hydroxide, for example. In particular, an acrylic resin, a methacrylic resin, polyacrylic acid ester, polymethacrylic acid ester, and a styrene resin; and crosslinking fine particles of these resins are preferable.

The average particle size of the particles preferably is 5 μm or more and less than 50 μm, and more preferably 10 μm or more and 30 μm or less. When the average particle size is less than 5 μm, it is difficult to form protrusions with a height of 4 μm or more on the surface of the ink receiving layer. When the average particle size is 50 μm or more, an erroneous blank or partial missing, for example, can appear in printing. These particles may be used alone or in combination of two or more types. As these particles, it is preferable to use as appropriate particles of Techpolymer MBX series, SBX series, BMX series, ARX series, MBX-S series, MBX-SS series, MB-C series, ACX series, or MBP series (produced by SEKISUI PLASTICS CO., Ltd.) with an average particle size of 5 to 50 μm; or particles of Chemisnow MX series, MR series, SX series, or SGP series (produced by Soken Chemical & Engineering Co., Ltd.) with an average particle size of 5 to 50 μm, for example. Herein, particles with an average particle size of 0.01 or more and less than 1 μm further may be added in order to improve the strength of the ink receiving layer.

When the entire weight of the resin component in the ink receiving layer is taken as 100 parts by weight, the amount of the particles added preferably is 0.1 parts by weight or more and 10 parts by weight or less, and more preferably 3 parts by weight or less, with respect to 100 parts by weight. When the amount added is 10 parts by weight or less, in particular 3 parts by weight or less, it is possible to secure the glossiness of the ink receiving layer.

Herein, when determining the average particle size and the amount of the particles added, it is necessary to make a determination as appropriate based on an actual observation on the height of the protrusions and the number of the protrusions on the surface of the ink receiving layer. The reason for this is that the height and the number of the protrusions on the surface of the ink receiving layer cannot be uniquely determined due to the average particle size and the amount of particles that are added.

Even when the particles are added, the 60 degree gloss of the surface of the ink receiving layer can be kept at 30 or more and 110 or less. Since the gloss of the ink receiving layer is determined by the surface roughness, conventionally, it has been held that particles to be contained in the ink receiving layer are preferable if their average particle size is 1 μm or less. However, in the present invention, even when particles with an average particle size of 5 μm or more are used, it is possible to provide a glossy information recording medium by keeping the amount of the particles added within the above-described range.

The 60 degree gloss more preferably is 55 or more in consideration of a view for the user. Furthermore, in this specification, the 60 degree gloss is measured with a measuring apparatus as set forth below and measurement conditions as set forth below. As a measuring apparatus, a “micro-TR1-gloss” (produced by BYK-Gardner GmbH) is used. Measurement conditions are as follows. Measurement is performed in the 60 degree gloss measurement mode, and the measuring apparatus is pressed against a face to be measured, and then an average value of measurement values at arbitrary five points is taken as the 60 degree gloss of a measurement sample.

The ink receiving layer preferably contains a water-soluble resin in order to attain a good ink absorbency and to prevent blurring in printing. As the water-soluble resin, it is possible to use at least one selected from the group consisting of polyvinyl alcohol, hydroxyalkyl cellulose, polyvinyl pyrrolidone, polyvinyl caprolactam, and copolymers thereof with another resin component, for example. Specific examples of the water-soluble resin include “HEC DAICEL” (produced by DAICEL CHEMICAL INDUSTRIES, LTD.); METOLOSE “60SH-03”, “60SH-15”, “60SH-50”, and “65SH-50” (produced by Shin-Etsu Chemical Co., Ltd.); PITZCOL “K90” and “K30” (produced by DAI-ICHI KOGYO SEIYAKU CO., LTD.); polyvinylpyrrolidone “K120”, “K90”, and “K60”, polyvinylpyrrolidone (PVP)/vinyl alcohol (VA) copolymer “E335”, “E535”, “E635”, and “E735”, and Viviprint “540”, “121”, and “200” (produced by International Speciality Products); and GOHSENOL “EG-40”, “EG-05”, “KL-03”, and “L-0302” (produced by The Nippon Synthetic Chemical Industry Co., Ltd.). Of these, hydroxyalkyl cellulose and polyvinyl caprolactam are preferable in terms of preventing clamp adhesion, due to their structure having a hydrophilicity slightly lower than that of polyvinyl pyrrolidone. In particular, it is also preferable to use a copolymer of hydroxyalkyl cellulose or polyvinyl caprolactam, and dimethylaminopropyl methacrylate or a salt thereof, in terms of preventing ink blurring during storage in a high temperature and high humidity environment.

The ink receiving layer preferably is cured further using a radiation curable resin in order to improve water resistance, thereby preventing blurring in a print image caused by a water droplet and the like. Radiation curable resins generally include radical reaction resins and ion reaction resins, but radical reaction resins preferably can be used because the reaction rate of ion reaction resins is low. Furthermore, as a resin component of a radiation curable resin, an acrylate-based monomer or a methacrylate-based monomer is used in view of weather resistance, durability, and the like, and this resin component preferably has a polyoxyethylene chain or a polyoxypropylene chain in order not to impair the ink absorbing ability of the ink receiving layer. Based on the number of radiation functional groups contained in one molecule, such resin components can be divided into monofunctional monomers containing one functional group and polyfunctional monomers containing a plurality of functional groups.

Examples of the monofunctional monomer include ethylene glycol monomethyl ether(meth)acrylate, ethylene glycol monoethyl ether(meth)acrylate, ethylene glycol monopropyl ether(meth)acrylate, ethylene glycol monobutyl ether(meth)acrylate, ethylene glycol mono(2-ethylhexyl) ether(meth)acrylate, ethylene glycol monophenyl ether(meth)acrylate, propylene glycol monomethyl ether(meth)acrylate, propylene glycol monoethyl ether(meth)acrylate, propylene glycol monopropyl ether(meth)acrylate, propylene glycol monobutyl ether(meth)acrylate, propylene glycol mono(2-ethylhexyl) ether(meth)acrylate, and propylene glycol monophenyl ether(meth)acrylate.

Furthermore, it is also possible to use diethylene glycol monomethyl ether (meth)acrylate, diethylene glycol monoethyl ether(meth)acrylate, diethylene glycol monopropyl ether(meth)acrylate, diethylene glycol monobutyl ether(meth)acrylate, diethylene glycol mono(2-ethylhexyl)ether(meth)acrylate, diethylene glycol monophenyl ether(meth)acrylate, dipropylene glycol monomethyl ether(meth)acrylate, dipropylene glycol monoethyl ether(meth)acrylate, dipropylene glycol monopropyl ether(meth)acrylate, dipropylene glycol monobutyl ether(meth)acrylate, dipropylene glycol mono(2-ethylhexyl) ether(meth)acrylate, and dipropylene glycol monophenyl ether(meth)acrylate, for example.

Furthermore, it is also possible to use triethylene glycol monomethyl ether(meth)acrylate, triethylene glycol monoethyl ether(meth)acrylate, triethylene glycol monopropyl ether(meth)acrylate, triethylene glycol monobutyl ether(meth)acrylate, triethylene glycol mono(2-ethylhexyl)ether(meth)acrylate, triethylene glycol monophenyl ether(meth)acrylate, tripropylene glycol monomethyl ether(meth)acrylate, tripropylene glycol monoethyl ether(meth)acrylate, tripropylene glycol monopropyl ether(meth)acrylate, tripropylene glycol monobutyl ether(meth)acrylate, tripropylene glycol mono(2-ethylhexyl) ether(meth)acrylate, and tripropylene glycol monophenyl ether(meth)acrylate, for example.

Example of the bifunctional monomer include ethylene glycol di(meth)acrylate, diethylene glycol di(meth)acrylate, triethylene glycol di(meth)acrylate, tetraethylene glycol di(meth)acrylate, pentaethylene glycol di(meth)acrylate, hexaethylene glycol di(meth)acrylate, ethylene glycol (400) di(meth)acrylate, ethylene glycol (600) di(meth)acrylate, propylene glycol di(meth)acrylate, dipropylene glycol di(meth)acrylate, tripropylene glycol di(meth)acrylate, tetrapropylene glycol di(meth)acrylate, pentapropylene glycol di(meth)acrylate, hexapropylene glycol di(meth)acrylate, propylene glycol (400) di(meth)acrylate, and propylene glycol (600) di(meth)acrylate.

Examples of the trifunctional or higher polyfunctional monomer include ethylene glycol modified trimethylolpropane tri(meth)acrylate, ethylene glycol modified pentaerythritol tri(meth)acrylate, ethylene glycol modified pentaerythritol tetra(meth)acrylate, ethylene glycol modified dipentaerythritol penta(meth)acrylate, ethylene glycol modified dipentaerythritol hexa(meth)acrylate, propylene glycol modified trimethylolpropane tri(meth)acrylate, propylene glycol modified pentaerythritol tri(meth)acrylate, propylene glycol modified pentaerythritol tetra(meth)acrylate, propylene glycol modified dipentaerythritol penta(meth)acrylate, and propylene glycol modified dipentaerythritol hexa(meth)acrylate.

In addition to the above, examples of a resin component of the radiation curable resin include hydroxyethyl (meth)acrylate, hydroxypropyl (meth)acrylate, hydroxybutyl (meth)acrylate, hydroxypentyl (meth)acrylate, phenoxylhydroxypropyl (meth)acrylate, chlorohydroxypropyl (meth)acrylate, diethylene glycol mono(meth)acrylate, triethylene glycol mono(meth)acrylate, polyethylene glycol mono(meth)acrylate, dipropylene glycol mono(meth)acrylate, polypropylene glycol mono(meth)acrylate, glycerin mono(meth)acrylate, glycerin di(meth)acrylate, pentaerythritol tri(meth)acrylate, phenyl glycidyl ether(meth)acrylate, dipentaerythritol penta(meth)acrylate, di(meth)acrylate, dimethyl (meth)acrylic amide, and diethyl (meth)acrylic amide of a bisphenol A modified epoxy resin, acryloyl morpholine, N-vinylpyrrolidone, 2-ethoxyethyl (meth)acrylate, 2-methoxyethyl (meth)acrylate, ethyl carbitol (meth)acrylate, and glycidyl (meth)acrylate.

As a radial ray for curing the radiation curable resin, a gamma ray, an electron beam, or an ultraviolet ray preferably can be used, but in particular, it is convenient to use an ultraviolet ray. Examples of a light source for irradiating an ultraviolet ray include a high-pressure mercury-vapor lamp, a metal halide lamp, and an ultraviolet ray LED lamp. The irradiation energy amount preferably is 150 to 2000 mJ/cm², and more preferably 250 to 1000 mJ/cm². When an ultraviolet ray is used, it is necessary that the resin component contains a photoinitiator. Examples of the photoinitiator include benzoin isopropyl ether, benzophenone, 2-hydroxy-2-methylpropiophenone, 1-hydroxycyclohexyl phenyl ketone, 2,4-diethyl thioxanthone, methyl o-benzoylbenzoate, 4,4-bisdiethyl aminobenzophenone, 2,2-diethoxyacetophenone, benzil, 2-chlorothioxanthone, diusopropyl thiozanson, 9,10-anthraquinone, benzoin, benzoin methyl ether, 2,2-dimethoxy-2-phenylacetophenone, 2-hydroxy-2-methyl-propiophenone, 4-isopropyl-2-hydroxy-2-methylpropiophenone, and α,α-dimethoxy-α-phenylacetone.

In order to adjust the water contact angle of the surface of the ink receiving layer, it is preferable that the radiation curable resin contains a silicon-containing monomer such as a silane coupling agent, a silicon-based defoaming agent, a silicon-based leveling agent, a silicon oil, a silicon-based slipping agent, and a silicon-based water repellent. Preferable examples of the silicon-containing monomer include alcohol-soluble monomers such as 3-acryloxypropyltrimethoxysilane, 3-methacryloxypropyltrimethoxysilane, 3-methacryloxypropyl methyldimethoxysilane, 3-methacryloxypropyl methyldiethoxysilane, 3-methacryloxy propyltriethoxysilane, silicon diacrylate, and silicon hexaacrylate. There is no specific limitation regarding the amount of the silicon-containing monomer added, but when the total weight of the water-soluble resin and the radiation curable resin is taken as 100 parts by weight, for example, the monomer is added within a range of 0.1 to 10 parts by weight with respect to 100 parts by weight. Within this range, the water contact angle of the surface of the ink receiving layer easily can be adjusted to 85° or more and 110° or less.

When a radiation curable resin is not used in the ink receiving layer, a silicon-containing resin obtained by radically polymerizing the silicon-containing monomer in advance may be applied to the ink receiving layer. Furthermore, the ink receiving layer may be formed by mixing a silicon-containing resin that has been polymerized in advance and the aforesaid water-soluble resin. In JP 2004-338206A described above, a method has been proposed in which a radical polymerizable resin containing N-vinylpyrrolidone and an alkoxysilyl group, and another radical polymerizable resin are mixed and copolymerized with, for example, a water-soluble peroxide, and then used as a mixture with another water-soluble resin. It is also possible to use such a composition for applying to the ink receiving layer.

Other than the radical polymerizable copolymer, the ink receiving layer may be formed using an urethane-based resin, a polyester-based resin, or the like. For example, it is possible to use SUPERFLEX “600”, “610”, “620”, “650”, and “300” series (produced by DAI-ICHI KOGYO SEIYAKU CO., LTD.); resins for an inkjet receiving layer “NS series” (produced by TAKAMATSU OIL & FAT CO., LTD); “PATELACOL IJ series” (produced by DAINIPPON INK AND CHEMICALS, INCORPORATED); and “Parasurf UP series” (produced by OHARA PARAGIUM CHEMICAL CO., LTD.). These resins may be used alone or as a mixture with the aforesaid water-soluble resin.

Furthermore, the ink receiving layer may contain a cationic copolymer in order to prevent blurring during a long period of storage. Preferable examples of the cationic copolymer include polydiallylamine-based, polyamidine-based, polyamine-based, and polyacrylamide-based copolymers, and salts of these copolymers. For example, it is possible to use “SHALLOL” series (produced by DAI-ICHI KOGYO SEIYAKU CO., LTD.); cationic polymers “IN-177A”, “TK Cation N”, and “IN-197” (produced by TAKAMATSU OIL & FAT CO., LTD); GLASCOL “FliO”, “F207”, “F209”, and “F307” (produced by Ciba Specialty Chemicals); and PAPYOGEN “P105” and “P138” (produced by SENKA). They may be used alone or as a mixture.

There is no specific limitation regarding a method for producing the ink receiving layer, and it is possible to form the ink receiving layer on a substrate by applying an application liquid containing the above-described particles, the water-soluble resin, and the radiation curable resin to the substrate by a method such as a spin-coating method, a dip-coating method, a bar-coating method, a blade-coating method, an airknife-coating method, a roll-coating method, and a screen printing method, and then irradiating with a radial ray to cure and dry the liquid. When a radiation curable resin is not contained in the application liquid, it is possible to form the ink receiving layer by heating instead of irradiating with a radial ray so that the liquid is dried.

The thickness of the ink receiving layer preferably is 1 to 100 μm, and more preferably 5 to 20 μm. When the thickness is less than 1 μm, it is difficult to keep and hold the added particles with an average particle size of 5 to 50 μm. When the thickness is more than 100 μm, the information recording medium may become warped.

In the case of an optical information recording medium, a substrate on which the ink receiving layer is formed is formed by laminating a first transparent support layer, a recording layer, a light reflection layer, an adhesive layer, a second transparent support layer, and a white protective layer in this order, for example. In the final processing, the ink receiving layer is formed on the white protective layer, and thus the optical information recording medium is completed. In this configuration, a light incident face is on the side of the first transparent support layer, and a label surface is on the side of the ink receiving layer.

There is no specific limitation regarding a material of the first transparent support layer, as long as it has a high optical transmission and a certain level of strength. For example, it is possible to use polymeric materials such as a polycarbonate resin, an acrylic resin, a methacrylic resin, a polystyrene resin, a vinyl chloride resin, an epoxy resin, a polyester resin, amorphousness polyolefine; and inorganic materials such as glass. In particular, a polycarbonate resin having a high optical transmission and a small optical anisotropy is preferable. Furthermore, there is no specific limitation regarding the shape of the first transparent support layer, and it may be plate-like or film-like, for example. Pits or guide grooves indicating recording position, or pits for information only for partial reproduction and the like may be provided on the surface of the first transparent support layer on the side of the recording layer. These grooves and pits are usually formed when producing the support layer by injection molding or casting, but may be formed by a laser cutting method or a 2P method (photo-polymer method) after producing the support layer. The thickness of the first transparent support layer usually is 250 to 950 μm.

There is no specific limitation regarding a material of the recording layer, as long as it can record information by being irradiated with a laser beam, and it is possible to use inorganic materials or organic materials. Examples of the inorganic materials include rare earth transition metal alloys such as a Tb/Fe/Co alloy and a Dy/Fe/Co alloy performing recording by using a light-induced thermo-magnetic effect. Furthermore, it is also possible to use materials containing chalcogen-based alloys such as a Ge/Te alloy and a Ge/Sb/Te alloy performing recording by using a phase change. Main examples of the organic materials include organic dyes. The organic material may be a mixture of a plurality of organic dyes, and a material other than a light absorbing material may be added to the organic material.

Examples of the organic dyes used for the recording layer include macrocyclic azaannulene-based dyes (such as a phthalocyanine dye, a naphthalocyanine dye, and a porphyrin dye), polymethine-based dyes (such as a cyanine dye, a merocyanine dye, and a squarilium dye), anthraquinone-based dyes, azulenium-based dyes, azo-based dyes, and indoaniline-based dyes. In particular, a phthalocyanine dye having a high durability and light resistance is preferable.

It is possible to form the recording layer by applying an application liquid in which the material for forming the recording layer has been dissolved into a solvent to the first transparent support layer by an application method such as a spin-coating method, a spray-coating method, a dip-coating method, and a roll-coating method, and then drying the liquid.

It is necessary that the solvent does not exert a harmful influence on the first transparent support layer. In the case of an ordinary optical information recording medium, it is possible to use aliphatic solvents and alicyclic hydrocarbon-based solvents such as hexane, heptane, octane, decane, and cyclohexane; aromatic hydrocarbon-based solvents such as toluene and xylene; ether-based solvents such as diethyl ether and dibutyl ether; alcohol-based solvents such as methanol, ethanol, isopropyl alcohol, and methyl cellosolve; and halogenated hydrocarbon-based solvents such as 1,2-dichloroethane, chloroform, for example. These solvents may be used alone or as a mixture.

Furthermore, the recording layer may be formed using a vacuum evaporation method. This method is effective, for example, when a material of the recording layer is difficult to dissolve into a solvent or when it is impossible to select a solvent that does not exert a harmful influence on the first transparent support layer. Moreover, various base layers may be provided between the recording layer and the first transparent support layer in order to prevent the recording layer from being deteriorated. For example, a layer made of an organic material such as polystyrene and polymethacrylic acid methyl or a layer made of an inorganic material such as SiO₂ may be formed as the base layer. The base layer may be a single layer or multiple layers formed by laminating a plurality of different types of layers. The thickness of the recording layer usually is 0.01 to 0.20 μm.

A light reflection layer is formed using a metal such as Au, Al, Pt, Ag, and Ni or an alloy thereof on the recording layer. A metal used for forming the light reflection layer preferably is a metal that is stable particularly against oxygen and water. The light reflection layer is formed by evaporation, sputtering, ion plating, or the like. An intermediate layer may be provided between the light reflection layer and the recording layer in order to improve adhesion between the layers or to improve reflectance. The thickness of the light reflection layer usually is 0.05 to 0.20 μm.

The second transparent support layer is disposed above the light reflection layer having the adhesive layer interposed therebetween. A material of the second transparent support layer may be the same as that of the first transparent support layer, and the thickness thereof usually is 250 to 950 μm. As a material of the adhesive layer, it is possible to use, for example, a radiation curable resin used for forming the ink receiving layer. The thickness of the adhesive layer usually is 5 to 20 μm.

The white protective layer is disposed so as to be in contact with the ink receiving layer, and has a function for providing clear writing and printing on the ink receiving layer. The white protective layer can be formed using an ultraviolet curable resin composition in which a photoinitiator and a white filler are contained in an ultraviolet curable monomer. It is possible to form the white protective layer by applying the ultraviolet curable resin composition to the second transparent support layer by a spin-coating method, a dip-coating method, a bar-coating method, a blade-coating method, an airknife-coating method, a roll-coating method, a screen printing method, or the like, and then irradiating with an ultraviolet ray to cure the composition.

Examples of the ultraviolet curable monomer include trimethylolpropane tri(meth)acrylate, acrylated isocyanurate, 1,4-butanediol di(meth)acrylate, 1,6-hexanediol di(meth)acrylate, neopentylglycol di(meth)acrylate, dicyclopentadienyl di(meth)acrylate, pentaerythritol tetra(meth)acrylate, and dipentaerythritol hexa(meth)acrylate, in addition to the above-described acrylate-based monomer and methacrylate-based monomer used for forming the ink receiving layer.

Examples of the photoinitiator include benzoin isopropyl ether, benzophenone, 2-hydroxy-2-methylpropiophenone, 1-hydroxycyclohexyl phenyl ketone, 2,4-diethyl thioxanthone, methyl o-benzoylbenzoate, 4,4-bisdiethyl aminobenzophenone, 2,2-diethoxyacetophenone, benzil, 2-chlorothioxanthone, diisopropyl thiozanson, 9,10-anthraquinone, benzoin, benzoin methyl ether, 2,2-dimethoxy-2-phenylacetophenone, 2-hydroxy-2-methyl-propiophenone, 4-isopropyl-2-hydroxy-2-methylpropiophenone, and α,α-dimethoxy-α-phenylacetone.

As the white filler, both of an organic filler and an inorganic filler can be used. Examples of the organic filler include fine particles made of an acrylic resin, a methacrylic resin, polyacrylic acid ester, polymethacrylic acid ester, a styrene resin, polyester, polycarbonate, a modified melamine resin, polyvinyl alcohol, polyacrylamide, polyvinyl pyrrolidone, rubber, and the like; crosslinking fine particles of these resins; and powders of lignin, protein, and cellulose. Examples of the inorganic filler include titanium oxide, silica, talc, clay, calcium carbonate, calcium silicate, barium sulphate, mica, diatomaceous earth silica, aluminium hydroxide, alumina, zirconium oxide, and zirconium hydroxide. These white fillers may be used alone or in combination of two or more types.

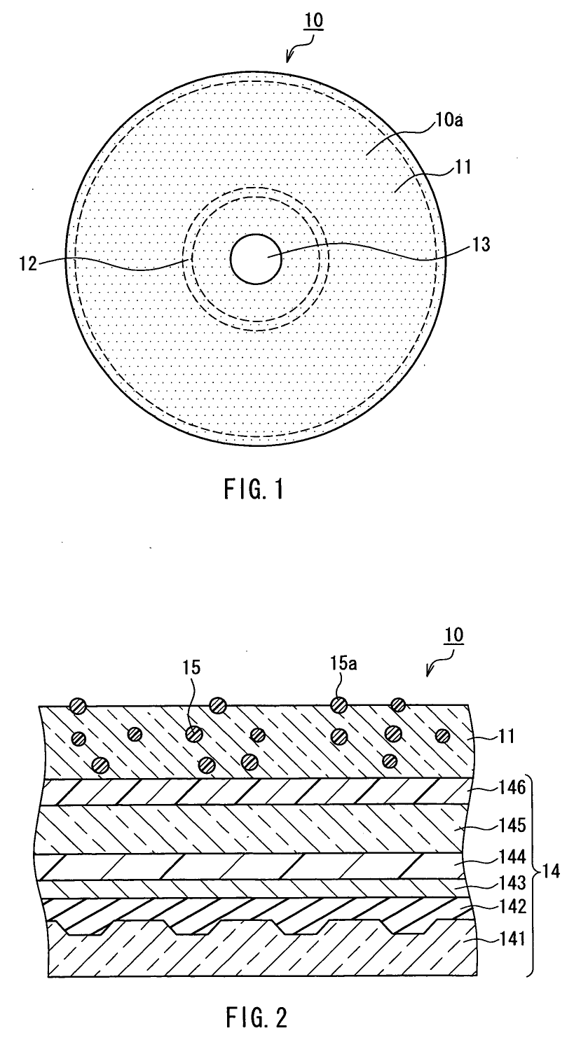

Next, the information recording medium according to the present invention is described based on the drawings. FIG. 1 is a plan view of an optical information recording medium that is one example of the information recording medium according to the present invention. In FIG. 1, an optical information recording medium 10 is provided with a label surface 10a having an ink receiving layer 11 that is a print area thereof and a clamp area 12, and a center hole 13 on the center thereof. Furthermore, the ink receiving layer 11 covers from the outer circumference of the label surface 10a over the clamp area 12, and further covers from the inner circumference of the clamp area 12 to the outer circumference of the center hole 13. Accordingly, it is possible to maximize the area of the ink receiving layer 11, and thus the print area can be enlarged.

FIG. 2 is a cross-sectional view of the main portions of the optical information recording medium in FIG. 1. Herein, in order to facilitate the understanding of the drawing, the ratio between the thicknesses of the layers in FIG. 2 may be different from the actual ratio. The optical information recording medium 10 is provided with the ink receiving layer 11 on a substrate 14. The substrate 14 is formed by laminating a first transparent support layer 141, a recording layer 142, a light reflection layer 143, an adhesive layer 144, a second transparent support layer 145, and a white protective layer 146 in this order. It should be noted that the configuration of the substrate 14 is shown as one example and there is no limitation thereto.

Furthermore, the water contact angle of the surface of the ink receiving layer 11 is set to 85° or more and 110° or less. Moreover, the ink receiving layer 11 contains particles 15 with an average particle size of 5 or more and less than 50 μm. Particles 15a that is a part of the particles 15 form protrusions with a height of 4 μm or more, by being exposed partially on the surface of the ink receiving layer 11. The number of the protrusions with a height of 4 μm or more is 20 pcs/mm² or more and 100 pcs/mm² or less. With this ink receiving layer 11, an information recording medium 10 does not adhere to a clamp even in a high temperature and high humidity environment, and the 60 degree gloss of the surface of the ink receiving layer can be kept within a range of 30 to 110.

In FIG. 1, the ink receiving layer 11 covers from the outer circumference of the label surface 10a to the outer circumference of the center hole 13, but it may cover from the outer circumference of the label surface 10a at least up to the clamp area 12, and further to a part of the inner side of the clamp area 12, as in the conventional optical information recording medium shown in FIG. 4. When the ink receiving layer 11 covers at least the clamp area 12, the information recording medium 10 does not adhere to a clamp even in a high temperature and high humidity environment, and the 60 degree gloss of the surface of the ink receiving layer can be kept within a range of 30 to 110.

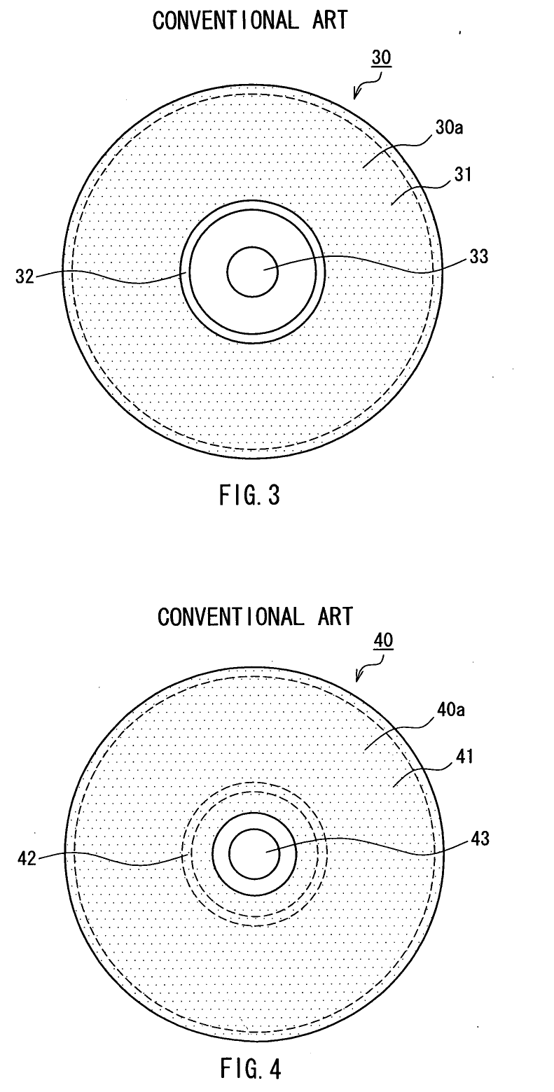

Furthermore, as in the conventional optical information recording medium shown in FIG. 3, the ink receiving layer 11 may cover from the outer circumference of the label surface 10a to the outer circumference of the clamp area 12. Also in this case, the information recording medium 10 does not adhere to a clamp even in a high temperature and high humidity environment, and the 60 degree gloss of the surface of the ink receiving layer can be kept within a range of 30 to 110.

### Embodiment 2

A second information recording medium according to the present invention has common properties with the information recording medium in Embodiment 1 in that a substrate and an ink receiving layer disposed on one main face of this substrate are provided and in that the water contact angle of the surface of the ink receiving layer is 85° or more and 110° or less, and more preferably 85° or more and 105° or less. A description of the common properties of the information recording medium of this embodiment and the information recording medium in Embodiment 1 may be omitted.

In this embodiment, the ink receiving layer contains particles with a particle size of 20 μm or more and 150 μm or less, and at least a part of these particles are exposed partially on the surface of the ink receiving layer. When the particle size is less than 20 μm, clamp adhesion can occur after printing. When the particle size is more than 150 μm, an erroneous blank can appear in printing. The number of the exposed particles is 75 pcs/mm² or more and 250 pcs/mm² or less, and more preferably 75 pcs/mm² or more and 160 pcs/mm² or less. When the number of the particles is less than 75 pcs/mm², clamp adhesion can occur after printing. When the number of the particles is more than 250 pcs/mm², an erroneous blank can appear in printing. The ink receiving layer generally contains fine particles in order to improve ink absorbency, but in the present invention, particles of a specific particle size are exposed on the surface of the ink receiving layer, so that clamp adhesion after printing is prevented.

There is no specific limitation regarding a method for counting the number of the particles, but it is possible to use the following method, for example. First, the surface of the ink receiving layer of the information recording medium is irradiated with light with an incident angle of 75°, and is observed using a metallographic microscope. Accordingly, shadows of the particles that are exposed on the surface of the ink receiving layer can be observed. These shadows are used so that the metallographic microscope is focused on the surface of the ink receiving layer. Next, in this state, the surface of the ink receiving layer is irradiated with light (vertical ray) that is perpendicular thereto, instead of light (slanting ray) with an incident angle of 75°. Black shadows that are observed at this time are taken as the particles that are exposed partially on the ink receiving layer. In this state, a metallographic microscope photograph of the surface of the ink receiving layer is taken. Next, the number of the particles with a particle size of 20 μm or more that are exposed partially on the surface of the ink receiving layer is counted based on the photograph in consideration of the scale factor of the photograph. When the observation is performed only with a vertical ray from the first stage, since a resin that usually is used for the ink receiving layer is transparent, it is difficult to distinguish particles on the surface from particles in the inner portion, and thus the metallographic microscope cannot be focused on the surface of the ink receiving layer. However, when the shadows of the particles formed with the slanting ray are used so that the metallographic microscope is focused on the surface of the ink receiving layer in advance, it is possible to observe only particles that are exposed on the surface of the ink receiving layer even in an observation using the vertical ray. More specifically, this photograph may be taken as photographs (72.5 mm×95.0 mm, scale factor: ×100) at least at three points. It should be noted that when the shadow of the particle is not observed as a circular shadow, it is preferable to take the diameter of a circle corresponding to the area of the shadow as the particle size.

There is no specific limitation regarding the type of the particles, but it is possible to use particles similar to those used for forming the protrusions in Embodiment 1. The average particle size of the particles preferably is 5 μm or more and less than 501m, and more preferably 10 μm or more and 30 μm or less. When the average particle size is less than 5 μm, it is difficult to expose the particles with a particle size of 20 μm or more on the surface of the ink receiving layer. When the average particle size is 50 μm or more, an erroneous blank or partial missing, for example, can appear in printing. These particles may be used alone or in combination of two or more types. As these particles, it is preferable to use as appropriate particles of Techpolymer MBX series, SBX series, BMX series, ARX series, MBX-S series, MBX-SS series, MB-C series, ACX series, or MBP series (produced by SEKISUI PLASTICS CO., Ltd.) with an average particle size of 5 to 50 μm; or particles of Chemisnow MX series, MR series, SX series, or SGP series (produced by Soken Chemical & Engineering Co., Ltd.) with an average particle size of 5 to 50 μm, for example. Herein, particles with an average particle size of 0.01 or more and less than 5 μm further may be added in order to improve the strength of the ink receiving layer.

When the entire weight of the resin component in the ink receiving layer is taken as 100 parts by weight, the amount of the particles added preferably is 0.1 parts by weight or more and 10 parts by weight or less, and more preferably 3 parts by weight or less, with respect to 100 parts by weight. When the amount added is 10 parts by weight or less, in particular 3 parts by weight or less, it is possible to secure the glossiness of the ink receiving layer.

Herein, when determining the average particle size and the amount of the particles added, it is necessary to make determination as appropriate based on an actual observation on the particle size and the number of the particles that are exposed on the surface of the ink receiving layer. The reason for this is that the particle size and the number of the particles that are exposed on the surface of the ink receiving layer cannot be uniquely determined due to the average particle size and the amount of particles that are added.

Even when the particles are added, the 60 degree gloss of the surface of the ink receiving layer can be kept at 30 or more and 110 or less. Since the gloss of the ink receiving layer is determined by the surface roughness, conventionally, it has been held that particles to be contained in the ink receiving layer are preferable if their average particle size is 1 μm or less. However, in the present invention, even when particles with an average particle size of 5 μm or more are used, it is possible to provide a glossy information recording medium by keeping the amount of the particles added within the above-described range. The 60 degree gloss more preferably is 55 or more in consideration of a view for the user.

The ink receiving layer of this embodiment is the same as the ink receiving layer of Embodiment 1, except the points described above, and thus a description thereof has been omitted. Furthermore, in the case of an optical information recording medium, a substrate on which the ink receiving layer is formed is formed by laminating a first transparent support layer, a recording layer, a light reflection layer, an adhesive layer, a second transparent support layer, and a white protective layer in this order, for example. In the final processing, the ink receiving layer is formed on the white protective layer, and thus the optical information recording medium is completed. In this configuration, a light incident face is on the side of the first transparent support layer, and a label surface is on the side of the ink receiving layer. In this embodiment, the first transparent support layer, the recording layer, the light reflection layer, the adhesive layer, the second transparent support layer, and the white protective layer may be similar to those described in Embodiment 1.

Next, the present invention specifically is described based on examples, but the present invention is not limited to the examples below.

First, an example corresponding to Embodiment 1 above is described.

### EXAMPLE 1

<Fabrication of Disk Substrate Provided with Optical Recording Layer>

A disk substrate provided with an optical recording layer was fabricated in the following manner.

First, a 20% acetone solution was prepared by dissolving an azo metal complex-based dye expressed by the chemical formula below into acetone, and then this solution was diluted with tetrafluoropropanol so that a solution containing 1% of the dye in the entire solution was obtained.

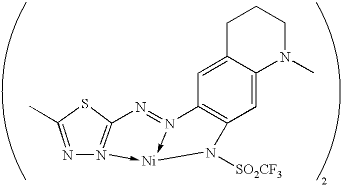

This solution was applied to a transparent substrate (diameter: 120 mm, thickness: 0.6 mm, diameter of the center hole: 14.5 mm) made of a polycarbonate injection molded plate in which a spiral groove with a track pitch of 1.6 μm, a groove width of 0.6 μm, and a groove depth of 0.1 μm was formed on one face, by spin-coating on a turn table that rotated at a speed increasing from 0 rpm to 250 rpm, and then dried for one hour at 80° C., and thus an organic dye recording layer with a film thickness of 150 nm was formed on the transparent substrate (first transparent support layer).

Next, this organic dye recording layer was sputtered so that an alloy layer mainly made of silver with a thickness of 100 nm was formed thereon using a sputtering apparatus “stella-100” (produced by SHIBAURA MECHATRONICS CORPORATION), and thus a light reflection layer was formed.

Furthermore, an ultraviolet curable resin “SD-698” (produced by DAINIPPON INK AND CHEMICALS, INCORPORATED) was applied as an adhesive layer to this light reflection layer. A transparent substrate (diameter: 120 mm, thickness: 0.6 mm, diameter of the center hole: 14.5 mm) made of a polycarbonate injection molded plate without a spiral groove was interposed on this ultraviolet curable resin, and the ultraviolet curable resin that was more than necessary was removed by rotating the layers at a high speed. Then, the ultraviolet curable resin was cured by being irradiated with an ultraviolet ray from the side of the transparent substrate (second transparent support layer), and thus the transparent substrate adhered to the light reflection layer.

Next, white ink made of titanium oxide and an ultraviolet curable resin was applied to this transparent substrate (second transparent support layer), and then was cured by being irradiated with an ultraviolet ray, and thus a white protective layer was formed.

<Formation of Ink Receiving Layer>

An application liquid for the ink receiving layer was prepared by mixing and agitating the components below.

(1) polyvinyl caprolactam copolymer: 200.0 parts by weight

(Viviprint “200” produced by International Speciality Products)

(2) trioxyethylene dimethacrylate: 20.0 parts by weight

(“LIGHT-ESTER 3EG” produced by Kyoeisha Chemical Co., Ltd.)

(3) 2-hydroxyethylacrylate: 20.0 parts by weight

(“LIGHT-ESTER HOA” produced by Kyoeisha Chemical Co., Ltd.)

(4) silicon hexaacrylate: 0.1 parts by weight

(“Ebecryl 1360” produced by Daicel-UCB Company, Ltd.)

(5) photoinitiator: 0.6 parts by weight

(“IRGACURE 2959” produced by Ciba Specialty Chemicals)

(6) crosslinking polymethacrylic acid methyl: 2.5 parts by weight

(Techpolymer “MBX12” produced by SEKISUI PLASTICS CO., Ltd., average particle size: 12 μm)

(7) alcohol: 120.0 parts by weight

Next, the application liquid was applied to the white protective layer of the disk substrate provided with the optical recording layer by a spin-coating method. More specifically, 5 g of the application liquid was dropped onto the inner circumference of the disk substrate and was applied to the entire label surface at a rotational speed of 1000 rpm, and then the application liquid that was more than necessary was removed by rotating the layers at a rotational speed of 1800 rpm for five seconds (spin-off condition). Then, the application liquid was irradiated with 500 mJ/cm² of an ultraviolet ray and dried for 10 minutes at 70° C., and thus a disk-type optical information recording medium (optical disk) in which the ink receiving layer covered from the outer circumference of the disk substrate to the outer circumference of the center hole as shown in FIG. 1 was obtained.

### EXAMPLE 2

An optical disk was fabricated in the same manner as that in Example 1, except that an application liquid for the ink receiving layer containing the components below was used, and that the spin-off condition that the layers be rotated at a rotational speed of 1400 rpm for five seconds was applied.

(1) hydroxyalkyl cellulose: 70.0 parts by weight

(METOLOSE “60SH-50” produced by Shin-Etsu Chemical Co., Ltd.)

(2) polyoxyethylene (300) diacrylate: 30.0 parts by weight

(“PEG300DA” produced by Daicel-UCB Company, Ltd.)

(3) 3-methacryloxy propyltriethoxysilane: 10.0 parts by weight

(“KBE503” produced by Shin-Etsu Chemical Co., Ltd.)

(4) crosslinking polymethacrylic acid methyl: 2.0 parts by weight

(Techpolymer “MBX15” produced by SEKISUI PLASTICS CO., Ltd., average particle size: 15 μm)

(5) photoinitiator: 0.6 parts by weight

(“IRGACURE 2959” produced by Ciba Specialty Chemicals)

(6) water: 550.0 parts by weight

(7) alcohol: 350.0 parts by weight

### EXAMPLE 3

An optical disk was fabricated in the same manner as that in Example 1, except that an application liquid for the ink receiving layer containing the components below was used, and that the spin-off condition that the layers be rotated at a rotational speed of 1400 rpm for five seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX12” produced by SEKISUI PLASTICS CO., Ltd., average particle size: 12 μm)

### EXAMPLE 4

An optical disk was fabricated in the same manner as that in Example 1, except that an application liquid for the ink receiving layer containing the components below was used, and that the spin-off condition that the layers be rotated at a rotational speed of 1400 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 4.5 parts by weight

(Techpolymer “MBX15” produced by SEKISUI PLASTICS CO., Ltd., average particle size: 15 μm)

### EXAMPLE 5

An optical disk was fabricated in the same manner as that in Example 1, except that an application liquid for the ink receiving layer containing the components below was used, and that the spin-off condition that the layers be rotated at a rotational speed of 1400 rpm for five seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX15” produced by SEKISUI PLASTICS CO., Ltd., average particle size: 15 μm)

### EXAMPLE 6

An optical disk was fabricated in the same manner as that in Example 1, except that an application liquid for the ink receiving layer containing the components below was used.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 5.0 parts by weight

(Techpolymer “MBX8” produced by SEKISUI PLASTICS CO., Ltd., average particle size: 8 μm)

### EXAMPLE 7

An optical disk was fabricated in the same manner as that in Example 1, except that an application liquid for the ink receiving layer containing the components below was used, and that the spin-off condition that the layers be rotated at a rotational speed of 1200 rpm for three seconds was applied.

(1) acrylic-based resin composition for ink receiving layer: 833.3 parts by weight

(“NS620X” produced by TAKAMATSU OIL & FAT CO., LTD)

(2) acrylic-based cationic polymer: 20.0 parts by weight

(“TK Cation N” produced by TAKAMATSU OIL & FAT CO., LTD)

(3) crosslinking polymethacrylic acid methyl: 2.5 parts by weight

(Techpolymer “MBX20” produced by SEKISUI PLASTICS CO., Ltd., average particle size: 20 μm)

### COMPARATIVE EXAMPLE 1

An optical disk was fabricated in the same manner as that in Example 1, except that an application liquid for the ink receiving layer containing the components below was used.

(1) polyvinyl caprolactam copolymer: 200.0 parts by weight

(Viviprint “200” produced by International Speciality Products)

(2) trioxyethylene dimethacrylate: 20.0 parts by weight

(“LIGHT-ESTER 3EG” produced by Kyoeisha Chemical Co., Ltd.)

(3) 2-hydroxyethylacrylate: 20.0 parts by weight

(“LIGHT-ESTER HOA” produced by Kyoeisha Chemical Co., Ltd.)

(4) photoinitiator: 0.6 parts by weight

(“IRGACURE 2959” produced by Ciba Specialty Chemicals)

(5) crosslinking polymethacrylic acid methyl: 6.0 parts by weight

(Techpolymer “MBX15” produced by SEKISUI PLASTICS CO., Ltd., average particle size: 15 μm)

(6) alcohol: 120.0 parts by weight

### COMPARATIVE EXAMPLE 2

An optical disk was fabricated in the same manner as that in Example 1, except that an application liquid for the ink receiving layer containing the components below was used.

(1) hydroxyalkyl cellulose: 70.0 parts by weight

(METOLOSE “60SH-50” produced by Shin-Etsu Chemical Co., Ltd.)

(2) polyoxyethylene (300) diacrylate: 30.0 parts by weight

(“PEG300DA” produced by Daicel-UCB Company, Ltd.)

(3) 3-methacryloxy propyltriethoxysilane: 17.5 parts by weight

(“KBE503” produced by Shin-Etsu Chemical Co., Ltd.)

(4) crosslinking polymethacrylic acid methyl: 2.0 parts by weight

(Techpolymer “MBX15” produced by SEKISUI PLASTICS CO., Ltd., average particle size: 15 μm)

(5) photoinitiator: 0.6 parts by weight

(“IRGACURE 2959” produced by Ciba Specialty Chemicals)

(6) water: 550.0 parts by weight

(7) alcohol: 350.0 parts by weight

### COMPARATIVE EXAMPLE 3

An optical disk was fabricated in the same manner as that in Example 1, except that an application liquid for the ink receiving layer containing the components below was used, and that the spin-off condition that the layers be rotated at a rotational speed of 1400 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX12” produced by SEKISUI PLASTICS CO., Ltd., average particle size: 12 μm)

### COMPARATIVE EXAMPLE 4

An optical disk was fabricated in the same manner as that in Example 1, except that an application liquid for the ink receiving layer containing the components below was used, and that the spin-off condition that the layers be rotated at a rotational speed of 1200 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX50” produced by SEKISUI PLASTICS CO., Ltd., average particle size: 50 μm)

A print test on the ink receiving layers, a clamp adhesion test (clamp test), and measurement of the thickness of the ink receiving layers were conducted on the optical disks of Examples 1 to 7 and Comparative Examples 1 to 4 by the following described methods. Table 1 shows the results together with the characteristics of the ink receiving layers of the optical disks. As the characteristics of the ink receiving layers, the 60 degree gloss of the surface, the number of protrusions, and the water contact angle of the surface are shown. The number of protrusions refers to the number per mm² of protrusions with a height of 4 μm or more on the surface of the ink receiving layer. It should be noted that the height and the number of the protrusions were obtained by the measurement method described in Embodiment 1.

<Print Test>

Solid printing and printing of characters of the respective ink colors were performed on the ink receiving layers using an inkjet printer “PIXUS iP3100” (produced by Canon Inc.). The evaluation criteria of the print test are as shown below. Table 1 shows the results.

(1) Good: Ink was not repelled, and thus printing was clear.

(2) Fair: Ink partially was repelled, and thus printing partially was unclear.

(3) Failure: Fine line characters were unclear and could not be read.

<Clamp Adhesion Test (Clamp Test)>

A disk clamp jig that had been removed from a DVD recorder “DV-DH250T” (produced by Hitachi, Ltd.) was used in this test. Solid printing was performed on the entire clamp areas of the ink receiving layers of the optical disks using an inkjet printer “Colorio PM-G800” (produced by SEIKO EPSON CORPORATION), and the optical disks were left for one day. Then, after the optical disks were left for two hours in an environment in which the temperature was 40° C. and the relative humidity was 80%, the clamps were attached to the optical disks, and the optical disks further were left in an environment in which the temperature was 40° C. and the relative humidity was 80%. After 24 hours, the clamps on the side of the optical recording faces were removed from the optical disks, and the adhesion between the optical disks and the clamps on the side of ink receiving layers was evaluated. The evaluation criteria of the clamp test are as shown below. Table 1 shows the results.

(1) Good: The optical disk naturally dropped off the clamp on the side of the ink receiving layer.

(2) Failure: The optical disk adhered to the clamp on the side of the ink receiving layer.

<Measurement of Thickness of Ink Receiving Layer>

The reflection spectrums of the ink receiving layers were measured using a thickness measurement system (MCPD detector: “MCPD-3000”, light source: “MC-2530”, produced by OTSUKA ELECTRONICS CO., LTD.). Based on the peak wave length of the obtained interference pattern, the thickness was obtained by taking the refractive index of the ink receiving layer as 1.4. The measurement was conducted at five points or more in an area of 30 to 45 mm from the center of the disk, and the average value was taken as the thickness of the ink receiving layer.

TABLE 1

| | thickness | | | | | | |
|---|---|---|---|---|---|---|---|
| | of ink | 60 | | water | | | |
| | receiving | degree | number of | contact | | | |
| | layer (μm) | gloss | protrusions | angle (°) | print test | clamp test | note |
| Ex. 1 | 10 | 71 | 22 | 85 | Good | Good | |
| Ex. 2 | 13 | 72 | 30 | 105 | Good | Good | |
| Ex. 3 | 12 | 60 | 25 | 103 | Good | Good | |
| Ex. 4 | 16 | 46 | 75 | 103 | Good | Good | |
| Ex. 5 | 13 | 64 | 53 | 103 | Good | Good | |
| Ex. 6 | 10 | 35 | 25 | 103 | Good | Good | |
| Ex. 7 | 19 | 63 | 36 | 95 | Good | Good | |
| Com. Ex. 1 | 10 | 53 | 117 | 67 | Fair | Failure | erroneous blank |
| Com. Ex. 2 | 10 | 76 | 37 | 112 | Failure | Good | blurring |
| Com. Ex. 3 | 16 | 55 | 15 | 103 | Good | Failure | |
| Com. Ex. 4 | 18 | 90 | 10 | 103 | Fair | Failure | erroneous blank |

As clearly shown in the results in Table 1, on the optical disks of Examples 1 to 7, the water contact angles of the surfaces of the ink receiving layers were within a range of 85° to 110°, and the numbers of protrusions with a height of 4 μm or more on the surfaces were 20 pcs/mm² or more and 100 pcs/mm² or less, which means that the results in both the print test and the clamp test were good. On the optical disk of Comparative Example 1, the water contact angle was less than 85°, which means that the results in the clamp test were poor, and the number of protrusions was more than 100 pcs/mm², which means that erroneous blanks appeared in a part of printing. On the optical disk of Comparative Example 2, the water contact angle was more than 110°, so that a printing defect (blurring) occurred. On the optical disks of Comparative Example 3 and Comparative Example 4, the numbers of protrusions with a height of 4 μm or more were less than 20 pcs/mm², which means that the results in the clamp test were poor. Furthermore, in Comparative Example 4, it is considered that since particles with an average particle size of 50 μm were used, the protrusions with a height of more than 50 μm were observed on the surface, so that erroneous blanks appeared in a part of printing. Moreover, in Example 4, Example 6, and Comparative Example 1, since the amounts of particles with an average particle size of 5 to 50 μm added were more than 3 parts by weight, the 60 degree gloss of the surfaces of the ink receiving layers was less than 55, so that the glossiness was comparatively poor.

Next, an example corresponding to Embodiment 2 above is described.

### EXAMPLE 8

<Fabrication of Disk Substrate Provided with Optical Recording Layer>

A disk substrate provided with an optical recording layer was fabricated in the same manner as that in Example 1.

<Formation of Ink Receiving Layer>

An application liquid for the ink receiving layer was prepared by mixing and agitating the components below.

(1) polyvinyl caprolactam copolymer: 200.0 parts by weight

(Viviprint “200” produced by International Speciality Products)

(2) trioxyethylene dimethacrylate: 20.0 parts by weight

(“LIGHT-ESTER 3EG” produced by Kyoeisha Chemical Co., Ltd.)

(3) 2-hydroxyethylacrylate: 20.0 parts by weight

(“LIGHT-ESTER HOA” produced by Kyoeisha Chemical Co., Ltd.)

(4) silicon hexaacrylate: 3.0 parts by weight

(“Ebecryl 1360” produced by Daicel-UCB Company, Ltd.)

(5) photoinitiator: 0.6 parts by weight

(“IRGACURE 2959” produced by Ciba Specialty Chemicals)

(6) crosslinking polymethacrylic acid methyl: 3.0 parts by weight

(Techpolymer “MBX15” produced by SEKISUI PLASTICS CO., Ltd., average particle size: 15 μm)

(7) alcohol: 120.0 parts by weight

Next, the application liquid was applied to the white protective layer of the disk substrate provided with the optical recording layer by a spin-coating method. More specifically, 5 g of the application liquid was dropped onto the inner circumference of the disk substrate and was applied to the entire label surface at a rotational speed of 1000 rpm, and then the application liquid that was more than necessary was removed by rotating the layers at a rotational speed of 1600 rpm for five seconds (spin-off condition). Then, the application liquid was irradiated with 500 mJ/cm² of an ultraviolet ray and dried for 10 minutes at 70° C., and thus a disk-type optical information recording medium (optical disk) in which the ink receiving layer covered from the outer circumference of the disk substrate to the outer circumference of the center hole as shown in FIG. 1 was obtained.

### EXAMPLE 9

An optical disk was fabricated in the same manner as that in Example 8, except that an application liquid for the ink receiving layer containing the components below was used.

(1) polyvinyl caprolactam copolymer: 200.0 parts by weight

(Viviprint “200” produced by International Speciality Products)

(2) trioxyethylene dimethacrylate: 20.0 parts by weight

(“LIGHT-ESTER 3EG” produced by Kyoeisha Chemical Co., Ltd.)

(3) 2-hydroxyethylacrylate: 20.0 parts by weight

(“LIGHT-ESTER HOA” produced by Kyoeisha Chemical Co., Ltd.)

(4) silicon hexaacrylate: 0.1 parts by weight

(“Ebecryl 1360” produced by Daicel-UCB Company, Ltd.)

(5) photoinitiator: 0.6 parts by weight

(“IRGACURE 2959” produced by Ciba Specialty Chemicals)

(6) crosslinking polymethacrylic acid methyl: 3.0 parts by weight

(Techpolymer “MBX20” produced by SEKISUI PLASTICS CO., Ltd., average particle size: 20 μm)

(7) alcohol: 120.0 parts by weight

### EXAMPLE 10

An optical disk was fabricated in the same manner as that in Example 8, except that an application liquid for the ink receiving layer containing the components below was used, and that the spin-off condition that the layers be rotated at a rotational speed of 1400 rpm for five seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX12” produced by SEKISUI PLASTICS CO., Ltd., average particle size: 12 μm)

### EXAMPLE 11

An optical disk was fabricated in the same manner as that in Example 8, except that an application liquid for the ink receiving layer containing the components below was used, and that the spin-off condition that the layers be rotated at a rotational speed of 1400 rpm for five seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX15” produced by SEKISUI PLASTICS CO., Ltd., average particle size: 15 μm)

### EXAMPLE 12

An optical disk was fabricated in the same manner as that in Example 8, except that an application liquid for the ink receiving layer containing the components below was used, and that the spin-off condition that the layers be rotated at a rotational speed of 1200 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 4.5 parts by weight

(Techpolymer “MBX15” produced by SEKISUI PLASTICS CO., Ltd., average particle size: 15 μm)

### EXAMPLE 13

An optical disk was fabricated in the same manner as that in Example 8, except that an application liquid for the ink receiving layer containing the components below was used, and that the spin-off condition that the layers be rotated at a rotational speed of 1400 rpm for five seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 2.0 parts by weight

(Techpolymer “MBX15” produced by SEKISUI PLASTICS CO., Ltd., average particle size: 15 μm)

### EXAMPLE 14

An optical disk was fabricated in the same manner as that in Example 8, except that an application liquid for the ink receiving layer containing the components below was used, and that the spin-off condition that the layers be rotated at a rotational speed of 1400 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 2.0 parts by weight

(Techpolymer “MBX20” produced by SEKISUI PLASTICS CO., Ltd., average particle size: 20 μm)

### COMPARATIVE EXAMPLE 5

An optical disk was fabricated in the same manner as that in Example 8, except that an application liquid for the ink receiving layer containing the components below was used.

(1) polyvinyl caprolactam copolymer: 200.0 parts by weight

(Viviprint “200” produced by International Speciality Products)

(2) trioxyethylene dimethacrylate: 20.0 parts by weight

(“LIGHT-ESTER 3EG” produced by Kyoeisha Chemical Co., Ltd.)

(3) 2-hydroxyethylacrylate: 20.0 parts by weight

(“LIGHT-ESTER HOA” produced by Kyoeisha Chemical Co., Ltd.)

(4) photoinitiator: 0.6 parts by weight

(“IRGACURE 2959” produced by Ciba Specialty Chemicals)

(5) crosslinking polymethacrylic acid methyl: 3.0 parts by weight

(Techpolymer “MBX15” produced by SEKISUI PLASTICS CO., Ltd., average particle size: 15 μm)

(6) alcohol: 120.0 parts by weight

### COMPARATIVE EXAMPLE 6

An optical disk was fabricated in the same manner as that in Example 8, except that an application liquid for the ink receiving layer containing the components below was used, and that the spin-off condition that the layers be rotated at a rotational speed of 2000 rpm for five seconds was applied.

(1) hydroxyalkyl cellulose: 70.0 parts by weight

(METOLOSE “60SH-50” produced by Shin-Etsu Chemical Co., Ltd.)

(2) polyoxyethylene (300) diacrylate: 30.0 parts by weight

(“PEG300DA” produced by Daicel-UCB Company, Ltd.)

(3) 3-methacryloxy propyltriethoxysilane: 17.5 parts by weight

(“KBE503” produced by Shin-Etsu Chemical Co., Ltd.)

(4) crosslinking polymethacrylic acid methyl: 2.0 parts by weight

(Techpolymer “MBX12” produced by SEKISUI PLASTICS CO., Ltd., average particle size: 121m)

(5) photoinitiator: 0.6 parts by weight

(“IRGACURE 2959” produced by Ciba Specialty Chemicals)

(6) water: 550.0 parts by weight

(7) alcohol: 350.0 parts by weight

### COMPARATIVE EXAMPLE 7

An optical disk was fabricated in the same manner as that in Example 8, except that an application liquid for the ink receiving layer containing the components below was used, and that the spin-off condition that the layers be rotated at a rotational speed of 1200 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX12” produced by SEKISUI PLASTICS CO., Ltd., average particle size: 12 μm)

### COMPARATIVE EXAMPLE 8

An optical disk was fabricated in the same manner as that in Example 8, except that an application liquid for the ink receiving layer containing the components below was used, and that the spin-off condition that the layers be rotated at a rotational speed of 1400 rpm for five seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 5.5 parts by weight

(Techpolymer “MBX15” produced by SEKISUI PLASTICS CO., Ltd., average particle size: 15 μm)

### COMPARATIVE EXAMPLE 9

An optical disk was fabricated in the same manner as that in Example 8, except that an application liquid for the ink receiving layer containing the components below was used, and that the spin-off condition that the layers be rotated at a rotational speed of 1200 rpm for three seconds was applied.

(1) acrylic-based resin composition for ink receiving layer: 833.3 parts by weight

(“NS620X” produced by TAKAMATSU OIL & FAT CO., LTD)

(2) crosslinking polymethacrylic acid methyl: 3.0 parts by weight

(Techpolymer “MBX50” produced by SEKISUI PLASTICS CO., Ltd., average particle size: 50 μm)

A print test on the ink receiving layers, a clamp adhesion test (clamp test), and measurement of the thickness of the ink receiving layers were conducted on the optical disks of Examples 8 to 14 and Comparative Examples 5 to 9 by the same method as described above. Herein, printing in the clamp test was performed using an inkjet printer “PIXUS iP3100” (produced by Canon Inc.) as in the print test. Table 2 shows the results together with the characteristics of the ink receiving layers of the optical disks. As the characteristics of the ink receiving layers, the 60 degree gloss of the surface, the number of particles, and the water contact angle of the surface are shown. The number of particles refers to the number per mm² of particles with a particle size of 20 μm or more that are exposed partially on the surface of the ink receiving layer. It should be noted that the number of particles was obtained by the measurement method described in Embodiment 2.

TABLE 2

| | thickness | | | | | | |
|---|---|---|---|---|---|---|---|
| | of ink | 60 | | water | | | |
| | receiving | degree | number of | contact | | | |
| | layer (μm) | gloss | particles | angle (°) | print test | clamp test | note |
| Ex. 8 | 12 | 87 | 145 | 92 | Good | Good | |
| Ex. 9 | 12 | 85 | 80 | 85 | Good | Good | |
| Ex. 10 | 12 | 60 | 135 | 103 | Good | Good | |
| Ex. 11 | 12 | 64 | 156 | 103 | Good | Good | |
| Ex. 12 | 18 | 40 | 240 | 103 | Good | Good | |
| Ex. 13 | 12 | 71 | 86 | 103 | Good | Good | |
| Ex. 14 | 15 | 75 | 76 | 103 | Good | Good | |
| Com. Ex. 5 | 12 | 96 | 140 | 67 | Good | Failure | |
| Com. Ex. 6 | 8 | 74 | 95 | 112 | Failure | Good | blurring |
| Com. Ex. 7 | 18 | 52 | 61 | 103 | Good | Failure | |
| Com. Ex. 8 | 12 | 45 | 305 | 103 | Failure | Good | |
| Com. Ex. 9 | 18 | 90 | 12 | 103 | Fair | Failure | erroneous blank |

As clearly shown in the results in Table 2, on the optical disks of Examples 8 to 14, the water contact angles of the surfaces of the ink receiving layers were within a range of 85° to 110°, and the numbers of particles with a particle size of 20 μm or more that were exposed partially on the surfaces were 75 pcs/mm² or more and 250 pcs/mm² or less, which means that the results in both the print test and the clamp test were good. On the optical disk of Comparative Example 5, the water contact angle was less than 85°, which means that the results in the clamp test were poor. On the optical disk of Comparative Example 6, the water contact angle was more than 110°, so that a printing defect (blurring) occurred. On the optical disk of Comparative Example 8, there were a large number of particles with a particle size of 20 μm or more that were exposed partially on the surface, so that a printing defect occurred. On the optical disks of Comparative Example 7 and Comparative Example 9, the numbers of particles with a particle size of 20 μm or more that were exposed partially on the surfaces were less than 75 pcs/mm², which means that the results in the clamp test were poor. Furthermore, in Example 12 and Comparative Example 8, since the amounts of particles with an average particle size of 15 μm added were more than 3 parts by weight, the 60 degree gloss of the surfaces of the ink receiving layers was less than 55, so that the glossiness was comparatively poor. Moreover, in Comparative Example 9, it is considered that since particles with an average particle size of 50 μm were used, the particles with a particle size of more than 150 μm were observed as particles that were exposed partially on the surface, so that erroneous blanks appeared in a part of printing.

As described above, the present invention can provide an information recording medium that does not adhere to a clamp in a high temperature and high humidity environment even when an ink receiving layer is provided up to a clamp area, and this information recording medium can be widely used as an information recording medium in the fields of audio software, computer software, game software, electronic publishing, and the like.

The invention may be embodied in other forms without departing from the gist thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information recording medium comprising a substrate and an ink receiving layer disposed on one main face of the substrate,
wherein the water contact angle of a surface of the ink receiving layer is at least 85° and at most 110°,
the surface of the ink receiving layer is provided with protrusions with a height of at least 4 μm, and
the number of the protrusions is at least 20 pcs/mm² and at most 100 pcs/mm².

2. The information recording medium according to claim 1,
wherein the 60 degree gloss of the surface of the ink receiving layer is at least 30 and at most 110.

3. The information recording medium according to claim 1,
wherein the ink receiving layer contains at least one selected from the group consisting of polyvinyl alcohol, hydroxyalkyl cellulose, polyvinyl pyrrolidone, polyvinyl caprolactam, and copolymers thereof with another resin component.

4. The information recording medium according to claim 1,
wherein the substrate is provided with a center hole and a clamp area that is positioned outside the center hole, and
the ink receiving layer covers from an outer circumference of the substrate at least up to the clamp area.

5. The information recording medium according to claim 4,
wherein the ink receiving layer covers from the outer circumference of the substrate to an outer circumference of the center hole.

6. The information recording medium according to claim 1,
wherein the substrate is provided with a support layer, a recording layer, a light reflection layer, and a protective layer.

7. An information recording medium comprising a substrate and an ink receiving layer disposed on one main face of the substrate,
wherein the water contact angle of a surface of the ink receiving layer is at least 85° and at most 110°,
the ink receiving layer contains particles with a particle size of at least 20 μm,
the particles include particles that are exposed partially on the surface of the ink receiving layer, and
the number of the exposed particles is at least 75 pcs/mm² and at most 250 pcs/mm².

8. The information recording medium according to claim 7,
wherein the 60 degree gloss of the surface of the ink receiving layer is at least 30 and at most 110.

9. The information recording medium according to claim 7,
wherein the ink receiving layer contains at least one selected from the group consisting of polyvinyl alcohol, hydroxyalkyl cellulose, polyvinyl pyrrolidone, polyvinyl caprolactam, and copolymers thereof with another resin component.

10. The information recording medium according to claim 7,
wherein the substrate is provided with a center hole and a clamp area that is positioned outside the center hole, and
the ink receiving layer covers from an outer circumference of the substrate at least up to the clamp area.

11. The information recording medium according to claim 10,
wherein the ink receiving layer covers from the outer circumference of the substrate to an outer circumference of the center hole.

12. The information recording medium according to claim 7,
wherein the substrate comprises a support layer, a recording layer, a light reflection layer, and a protective layer.
